(19) United States
(12) Patent Application Publication
(10) Pub. No.: US 2005/0177520 A1
(43) Pub. Date: Aug. 11, 2005

(54) System and method of authenticating a transaction

(76) Inventors: Albertus Jacobus Pretorius, Pretoria (ZA); Alwyn Jakobus Hoffman, Potchefstroom (ZA)

Correspondence Address: NIXON & VANDERHYE, PC, 901 NORTH GLEBE ROAD, 11TH FLOOR, ARLINGTON, VA, 22203, US

(21) Appl. No.: 10/502,848

(22) PCT Filed: Jan. 28, 2003
(86) PCT No.: PCT/ZA03/00012

(30) Foreign Application Priority Data
Jan. 29, 2002 (ZA) 2002/0779

(51) Int. Cl. H04L 9/00

(52) U.S. Cl. 705/67

(57) ABSTRACT

A method of collecting evidence relating to a transfer of a transferable article comprises the steps of capturing data relating to the article, data relating to a receiver of the article, data relating to a transferor of the article, data relating to a transaction sequence number and data and data relating to a time and place of the transaction. The captured data is encrypted by a private key of a first asymmetric encryption key pair associated with a trusted field data recorder and transmitted to a central database. At the database, the processor adds data relating to the time of receipt and data relating to a database recordal sequence number, to form a database data collection. The database data collection is encrypted utilizing a private key of a second asymmetric encryption key pair, before the encrypted data is recorded in the database.

### TECHNICAL FIELD

THIS invention relates to a method and system for distributing products or goods along a distribution chain and for recording evidence relating to transactions along the chain.

It is well known that manufacturers of goods distribute those goods to the market via a number of intermediaries. Such intermediaries may include distributors, wholesalers and retailers. The retailers then eventually sell the goods to consumers. It is also well known that pilferage of the genuine goods often occur along this chain. In some cases, the pilfered goods are replaced in the chain with gray or even pirate goods. Known systems for monitoring the flow of goods along the chains generate a mark or identifier to be associated with and applied to an article centrally. This mark is then associated with the article and is monitored along the chain. Such marks are cloneable and do not provide for suitable and reliable evidence relating to transfers of the article in the chain to be gathered, and are hence not satisfactory.

### OBJECT OF THE INVENTION

Accordingly it is an object of the present invention to provide a method and system of recording data relating to transfers or transactions in a chain with which the applicant believes the aforementioned disadvantages may at least be alleviated.

### SUMMARY OF THE INVENTION

According to the invention there is provided a method of recording data relating to a transfer of a transferable article, the method comprising the steps of:
utilizing a trusted recorder to capture and yield captured data comprising data relating to at least the article;
securing the captured data utilizing an encryption key of an encryption system; and
recording the secured data in a database,
   thereby to generate digital evidence relating to the transfer transaction.

The captured data may further comprise data relating to a receiver of the article.

The captured data may further comprise data relating to a transferor of the article.

The data relating to the transferor and/or receiver may comprise data relating to at least one of an identification code and biometric data.

The data relating to the article may comprise data relating to an inherent feature of the article which is unique to one of the article and a group of such articles to which the article belongs.

The captured data may further comprise at least one of data relating to a time of the transfer and data relating to a place of the transfer.

The capturing may be performed by a transfer transaction data recorder which is associated with a respective unique identification number and the captured data may further comprise to at least one of data relating to the identification number and data relating to a transfer transaction sequence number.

The encryption key preferably is a private key of an asymmetric encryption key pair also comprising a public key.

The private key is preferably unique to the data recorder, is kept secret and the public key may be made available according to rules of a public key infrastructure.

The step of securing the captured data may comprise computing a Hash of the captured data and encrypting the Hash with the private key, to form digitally signed transaction data.

The digitally signed transaction data may be communicated to the database.

The database may be controlled by a trusted third party.

The method may comprise the further steps of adding to the digitally signed transaction data at least one of data relating to a time of receipt of the digitally signed transaction data at the database and data relating to a received transaction sequence number for the database, to form database transaction data.

The database transaction data may be digitally signed by utilizing a private key of an asymmetric encryption key pair associated with and unique to the database, before it is recorded in the database.

Also included within the scope of the present invention is a method of verifying data relating to a transfer of a transferable article comprising the steps of recording the data as herein defined and/or described, subsequently retrieving the recorded data and decrypting the data.

Still further included within the scope of the present invention is a transfer transaction data recorder comprising:
a processor;
a data entry mechanism connected to the processor;
a memory arrangement connected to the processor;
a real time clock connected to the processor;
a physical position determining unit connected to the processor;
a transaction counter connected to the processor;
a communications path interface; and
a data encryptor associated with an encryption key pair;
the processor being operative to assemble a data collection comprising at least one of: data received via the data entry mechanism, recorder identification data received from the memory arrangement, real time data received from the real time clock, position data received from the position determining unit, and transfer transaction sequence data received from the counter and to control the encryptor to encrypt the data collection utilizing one key of the key pair, before communicating the encrypted data collection via the communications path.

Yet further included within the scope of the present invention is a system for recording data relating to a transfer of a transferable article, the system comprising:
at least one transfer transaction data recorder comprising a processor for capturing transaction data relating to the transfer and which data includes data relating to at least one of the article, a transferor and a receiver of the article; and a first encryptor for encrypting the captured data utilizing one key of a first encryption key pair associated with the recorder; and
a remote database for storing the encrypted transaction data.

The database may be associated with a processor comprising a second encryptor and the processor associated with the database may be operative to add additional data to said encrypted transaction data to form database transaction data and to cause the second encryptor to encrypt the database transaction data utilizing one key of a second key pair associated with and unique to the database, before recording the encrypted database transaction data in the database.

The system may further comprise a decryptor for utilizing another key of the second key pair to decrypt the encrypted database transaction data and a decryptor for utilizing another key of the first key pair, to decrypt the encrypted captured data.

### BRIEF DESCRIPTION OF THE ACCOMPANYING DIAGRAMS

The invention will now further be described, by way of example only, with reference to the accompanying diagrams wherein:

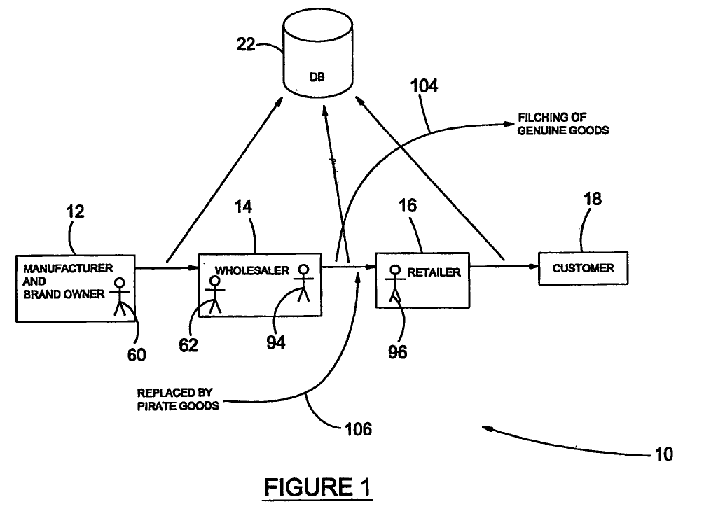

FIG. 1 is a block and flow diagram of a typical distribution chain of transferable goods;

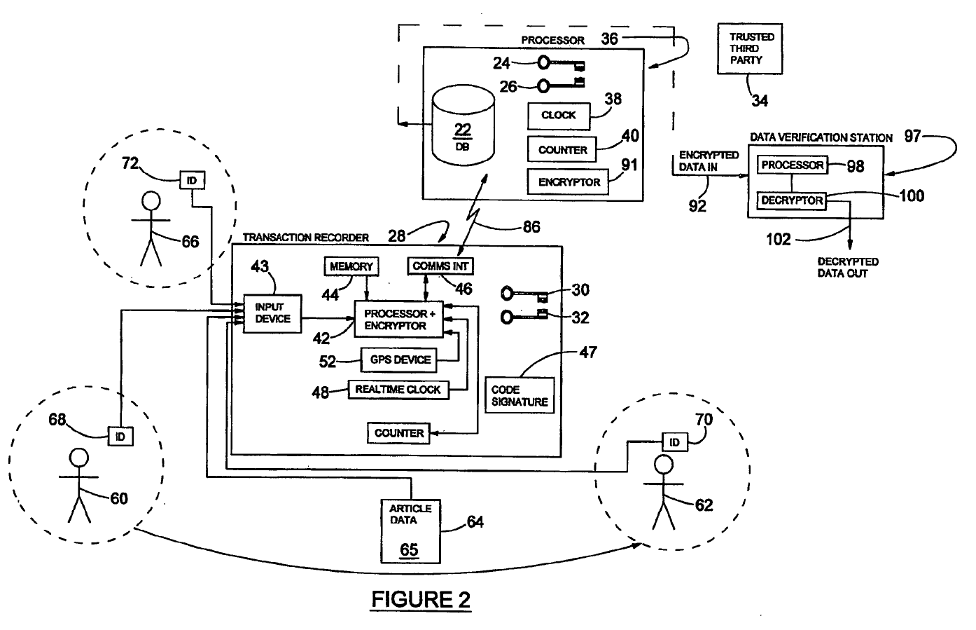

FIG. 2 is a block diagram of a system according to the invention for recording data relating to a transfer of goods from a transferor to a receiver;

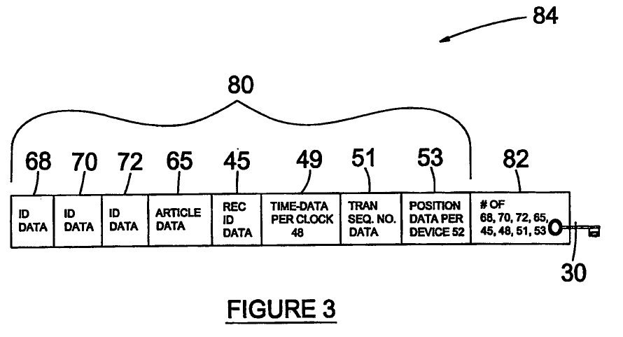

FIG. 3 is a diagrammatic representation of a digitally signed transaction data collection of high integrity prepared by a trusted transaction recorder forming part of the system and which is transmitted to a central digital evidence database forming part of the system; and

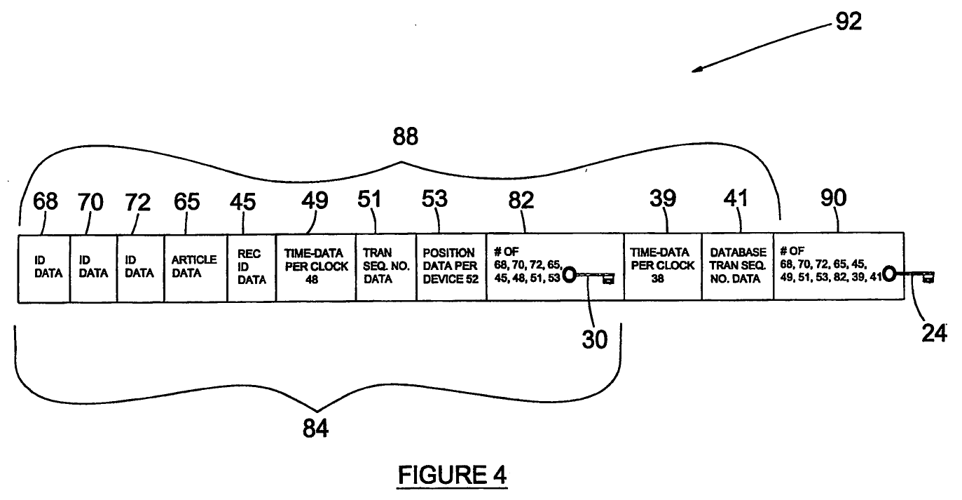

FIG. 4 is a diagrammatic representation of a digitally signed database transaction data collection of high integrity which is stored in the database.

### DESCRIPTION OF A PREFERRED EMBODIMENT OF THE INVENTION

A known distribution chain of transferable and transportable articles or goods is shown at 10 in FIG. 1.

The goods originate from a manufacturer 12 who normally is also the owner of a brand or mark applied to the goods. The manufacturer transfers the goods to a plurality of wholesalers one of which is shown at 14. The wholesaler 14 in turn distributes the goods to a plurality of retailers one of which is shown at 16. The retailer 16 offers the goods for sale to customers 18.

It is known that goods are often filched in a storeroom of one of the aforementioned parties and even replaced by gray or even pirate goods. The filching and replacement may also happen while in transito from a transferor of the goods (such as wholesaler 14) to a receiver to be, such as retailer 16.

The object of the present invention is to record data in a trusted digital evidence database in a reliable manner so that it may serve as evidence of a transfer or transaction and preferably of an entire sequence of transfers of the goods.

In this specification, a transfer of articles from a transferor (such as delivery person 60 of manufacturer 12) to a receiver (such as receiver person 62 of wholesaler 14) is referred to as a transaction. Data relating to each transaction along the chain 10 is captured by trusted field recorders or readers, digitally secured and stored centrally in a trusted digital evidence database 22 to be available for scrutiny and processing, as hereinafter described.

As shown in FIG. 2, the system 20 according to the invention comprises the central digital evidence database 22 having associated therewith a private key 24 and an associated public key 26 of an asymmetric encryption key pair. The system further comprises a plurality of physical and digital tamper evident field transaction recorders, at least some of which are portable and only one of which is shown at 28. The recorder in use serves as a real time electronic digital witness of the transaction and data relating to the transaction is captured, secured and stored to serve as non-manipulatable and non-repudiable evidence. Each transaction recorder is also associated with an own and unique public key 30 and associated private key 32 of a unique asymmetric encryption key pair. The public key 30 of the database and the public keys 32 of all the transaction recorders are certified in known manner in terms of a known public key infrastructure (PKI) process with an independent and trusted third party 34. The private keys are kept secret and used by the recorders and a database processor only. The transaction recorders hence constitute trusted extensions of the digital evidence database 22.

A processor 36 cooperating with the database 22 comprises a tamper proof real time clock 38 providing time data 39 and a tamper proof transaction counter 40, providing data 41 relating to a database transaction sequence number. The database 22 is also associated with a unique encryption key pair.

Each transaction recorder 28 comprises a processor 42, a data input device 43, a memory arrangement 44, a data communications interface 46, a tamper proof real time clock 48 for providing time data 49, a tamper proof transaction counter 50 for providing data 51 relating to a transaction sequence number and physical position determining means, such as a global position system (GPS) device 52, for providing position data 53. Time data 49 may also be derived from the GPS. A unique ID code 45 for the recorder is permanently embedded in the memory arrangement 44. The reader is rendered digitally tamper evident by code signing in known manner non-variable computer program code resident in the reader and which may include the key pair 30, 32 and the ID code 45. A code signature is shown at 47 in FIG. 2.

Reference is now made to FIGS. 1 to 3 and to the first transfer or transaction in the chain, that is between manufacturer 12 and wholesaler 14. At the time of the transfer of the articles 64, the following data is entered via input device 43 and captured by the portable transaction recorder 28 which may be carried and operated by an independent operator 66: identification data 68 (such as an ID number, password, biometric data etc) relating to delivery person 60; similar identification data 70 relating to receiver person 62; similar identification data 72 relating to operator 66; and data 65 relating to the articles 64. The aforementioned data is preferably captured within a predetermined time window, to ensure that all three parties and the articles are present at transfer, thereby to avoid tampering with input data. The data 65 relating to the article may be digital data relating to a unique feature of the article or a class of such articles to which the article belongs. A system for and method of capturing this data is disclosed in the applicant's co-pending International Application Number PCT/ZA02/00070 entitled “System and Method of Authenticating an Article”, which is incorporated herein by reference.

Referring to FIGS. 2 and 3, in a next step, the processor 42 of the recorder 28 adds to the aforementioned data, the following: data 45 relating to an identity of the recorder obtained from memory arrangement 44, data 49 relating to time of the transaction obtained from clock 48, data 51 relating to a recorder transaction sequence number obtained from counter 50 and data 53 relating to a physical position of the transaction obtained from device 52, to form a transaction data collection 80 shown in FIG. 3. The processor 42 automatically increments the count data 51 of the counter 50 at the start of a new transaction.

In a further step the processor 42 computes a Hash of the collection 80 and utilizes private key 30 to encrypt the Hash and to form a digest 82, thereby digitally to sign the transaction data collection 80 in known manner. The result is a digitally signed transaction data collection 84, which is transmitted via communications channel 86 (shown in FIG. 2) to the processor 36 at database 22.

As shown in FIG. 4, at the processor 36 there is added to the digitally signed transaction data collection 84, data 39 obtained from clock 38 relating to the time of receipt of the digitally signed transaction data collection 84 and data 41 relating to a transaction sequence number for the database obtained from counter 40, to form a database transaction data collection 88.

In a next step, the processor 36 causes the database transaction data collection 88 to be signed digitally by encryptor 91 (shown in FIG. 2) at 90 as hereinbefore described, utilizing the private key 24 associated with the database. The digitally signed database transaction data collection 92 is stored in the database 22.

Similarly, corresponding data is captured, secured and stored in the database 22 when delivery person 94 of wholesaler 14 transfers the goods to receiver person 96 of retailer 16. In this case a recorder 28 which may be permanently located at the premises of retailer 16 is used.

Should it later transpire that an article purchased by customer 18 is not a genuine article which originated from manufacturer 12, but a gray or pirate article, the aforementioned database transaction data relating to each of the transactions may be retrieved from database 22. The data 92 is processed at data verification station 97 comprising a processor 98 and a decryptor 100 by decrypting the data utilizing the public key 26 associated with the database and the public key 32 associated with the relevant recorder. The decrypted data 102 is then analyzed to investigate the parties and articles involved in each transaction. The database 22 and verification station 97 may be operated and controlled by a common trusted party, alternatively by different trusted parties. To illustrate the operation, it may be assumed that genuine articles were filched while in transito to retailer 16 as shown at 104 in FIG. 1, and replaced by pirate goods as shown at 106 in FIG. 1. The decrypted database data collection 102 relating to the second transaction will provide evidence relating to the identity of the parties involved in the transaction and the articles involved. Pirate articles not identifiable are hence traceable at that point in the chain.

The sequence numbers used at the recorder 28 and at the database 22 ensure that transaction data collections and database transaction data collections are not deleted or lost.

Furthermore, the digital signatures ensure non-repudiation and may facilitate proof of originality and integrity.

1. A method of recording data relating to a transfer of a transferable article, the method comprising the steps of:
utilizing a trusted recorder to capture and yield captured data comprising data relating to at least the article;
securing the captured data utilizing an encryption key of an encryption system; and
recording the secured data in a database, thereby to generate digital evidence relating to the transfer transaction.

2. A method as claimed in claim 1 wherein the captured data further comprises data relating to a receiver of the article.

3. A method as claimed in claim 2 wherein the captured data further comprises data relating to a transferor of the article.

4. A method as claimed in claim 3 wherein the data relating to at least one of the transferor and receiver comprises data relating to at least one of an identification code and biometric data.

5. A method as claimed in claim 1 wherein the data relating to the article comprises data relating to an inherent feature of the article which is unique to one of the article and a group of such articles to which the article belongs.

6. A method as claimed in claim 1 wherein the captured data further comprises at least one of data relating to a time of the transfer and data relating to a place of the transfer.

7. A method as claimed in claim 1 wherein the capturing is performed by a transfer transaction data recorder which is associated with a respective unique identification number and wherein the captured data further comprises at least one of data relating to the identification number and data relating to a transfer transaction sequence number.

8. A method as claimed in claim 1 wherein the encryption key is a private key of an asymmetric encryption key pair also comprising a public key.

9. A method as claimed in claim 8 wherein the private key is kept secret and the public key is made available according to rules of a public key infrastructure.

10. A method as claimed in claim 8 wherein the key pair is associated with the recorder and wherein the step of securing the captured data comprises computing a Hash of the captured data and encrypting the Hash with the private key, to form digitally signed transaction data.

11. A method as claimed in claim 10 wherein the digitally signed transaction data is communicated to the database.

12. A method as claimed in claim 1 wherein the database is controlled by a trusted third party.

13. A method as claimed in claim 10 comprising the steps of adding to the digitally signed transaction data at least one of data relating to a time of receipt of the digitally signed transaction data at the database and data relating to a received transaction sequence number for the database, to form database transaction data.

14. A method as claimed in claim 13 wherein the database transaction data is digitally signed by utilizing a private key of an asymmetric encryption key pair associated with the database, before it is recorded in the database.

15. A method of verifying data relating to a transfer of a transferable article comprising the steps of recording the data as claimed in claim 1, subsequently retrieving the recorded data and decrypting the data.

16. A transfer transaction data recorder comprising:
a processor;
a data entry mechanism connected to the processor;
a memory arrangement connected to the processor;
a real time clock connected to the processor;
a physical position determining unit connected to the processor;
a transaction counter connected to the processor;
a communications path interface; and
a data encryptor associated with an encryption key pair;
the processor being operative to assemble a data collection comprising at least one of: data received via the data entry mechanism, recorder identification data received from the memory arrangement, real time data received from the real time clock, position data received from the position determining unit, and transfer transaction sequence data received from the counter and to control the encryptor to encrypt the data collection utilizing one key of the key pair, before communicating the encrypted data collection via the communications path.

17. A system for recording data relating to a transfer of a transferable article, the system comprising:
at least one transfer transaction data recorder comprising a processor for capturing transaction data relating to the transfer and which data includes data relating to at least one of the article, a transferor and a receiver of the article;
a first encryptor for encrypting the captured data utilizing one key of a first encryption key pair associated with the recorder; and
a remote database for storing the encrypted transaction data.

18. A system as claimed in claim 17 wherein the database is associated with a processor comprising a second encryptor and wherein the processor associated with the database is operative to add additional data to said encrypted transaction data to form database transaction data and to cause the second encryptor to encrypt the database transaction data utilizing one key of a second key pair, before recording the encrypted database transaction data in the database.

19. A system as claimed in claim 18 comprising a decryptor for utilizing another key of the second key pair to decrypt the encrypted database transaction data and a decryptor for utilizing another key of the first key pair, to decrypt the encrypted captured data.
